(19) United States
(12) Patent Application Publication
(10) Pub. No.: US 2024/0427562 A1
(43) Pub. Date: Dec. 26, 2024

(54) PROGRAM GENERATION DEVICE AND PROGRAM GENERATION METHOD

(71) Applicant: KABUSHIKI KAISHA YASKAWA DENKI, Kitakyushu-shi (JP)

(72) Inventors: Yuki OE, Kitakyushu-shi (JP); Taiki TAKAYAMA, Kitakyushu-shi (JP); Kanako TOMIHARA, Kitakyushu-shi (JP); Arata TAKAKI, Kitakyushu-shi (JP)

(73) Assignee: KABUSHIKI KAISHA YASKAWA DENKI, Kitakyushu-shi (JP)

(21) Appl. No.: 18/824,991

(22) Filed: Sep. 5, 2024

Related U.S. Application Data
(63) Continuation of application No. PCT/JP2023/008895, filed on Mar. 8, 2023.

(30) Foreign Application Priority Data
Mar. 8, 2022 (JP) 2022-035459

(51) Int. Cl. G06F 8/30

(52) U.S. Cl. CPC G06F 8/30

(57) ABSTRACT

A generation device for generating an action program for a robot based on an operation of a user includes processing circuitry that generates skill information including skills each corresponding to a relative robot action, stores the skill information in a skill database, generates a task including skills each associating with action reference coordinates that serve as a reference for the relative robot action, stores the task in a task database, generates a master including tasks associating with the robot, and stores the master in a master database.

### CROSS-REFERENCE TO RELATED APPLICATIONS

The present application is a continuation of and claims the benefit of priority to International Application No. PCT/JP2023/008895, filed Mar. 8, 2023, which is based upon and claims the benefit of priority to Japanese Application No. 2022-035459, filed Mar. 8, 2022. The entire contents of these applications are incorporated herein by reference.

### BACKGROUND OF THE INVENTION

### Field of the Invention

The present invention relates to a program generation device and a program generation method.

### Description of Background Art

Japanese Patent No. 6455646 describes a programming assistance device for a robot. The entire contents of this publication are incorporated herein by reference.

### SUMMARY OF THE INVENTION

According to one aspect of the present invention, a generation device for generating an action program for a robot based on an operation of a user includes processing circuitry that generates skill information including skills each corresponding to a relative robot action, stores the skill information in a skill database, generates a task including skills each associating with action reference coordinates that serve as a reference for the relative robot action, stores the task in a task database, generates a master including tasks associating with the robot, and stores the master in a master database.

According to another aspect of the present invention, a generation method for generating an action program for a robot includes generating, using processing circuitry, skill information including skills each corresponding to a relative robot action, storing, using the processing circuitry, the skill information in a skill database, generating, using the processing circuitry, a task including skills and each associating with action reference coordinates that serve as a reference for the relative robot action, storing, using the processing circuitry, the task in a task database, generating, using the processing circuitry, a master including tasks associating with a robot, and storing, using the processing circuitry, the master in a master database.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a schematic diagram illustrating an example of a structure of a robot system;

FIG. 2 is a block diagram illustrating an example of functional structures of a robot controller and a program generation device;

FIG. 3 is a block diagram illustrating an example of hardware structures of the robot controller and the program generation device;

FIG. 4 is a flowchart illustrating an example of a program generation procedure;

FIG. 5 is a schematic diagram illustrating an example of a main screen;

FIG. 6 is a flowchart illustrating an example of a skill generation procedure;

FIG. 7 is a schematic diagram illustrating an example of a skill generation screen;

FIG. 8 is a schematic diagram illustrating an example of a preview screen;

FIG. 9 is a flowchart illustrating an example of a task generation procedure;

FIG. 10 is a schematic diagram illustrating an example of a task generation screen;

FIG. 11 is a schematic diagram illustrating an example of a skill selection screen;

FIG. 12 is a flowchart illustrating an example of a master generation procedure;

FIG. 13 is a schematic diagram illustrating an example of a master generation screen;

FIG. 14 is a schematic diagram illustrating an example of a task selection screen;

FIG. 15 is a schematic diagram illustrating an example of a condition setting screen;

FIG. 16 is a flowchart illustrating an example of a program generation procedure;

FIG. 17 is a flowchart illustrating an example of a simulation procedure;

FIG. 18 is a flowchart illustrating an example of a calibration procedure;

FIG. 19 is a flowchart illustrating an example of a program registration procedure; and

FIG. 20 is a flowchart illustrating an example of a control procedure.

### DETAILED DESCRIPTION OF THE EMBODIMENTS

Embodiments will now be described with reference to the accompanying drawings, wherein like reference numerals designate corresponding or identical elements throughout the various drawings.

### Robot System

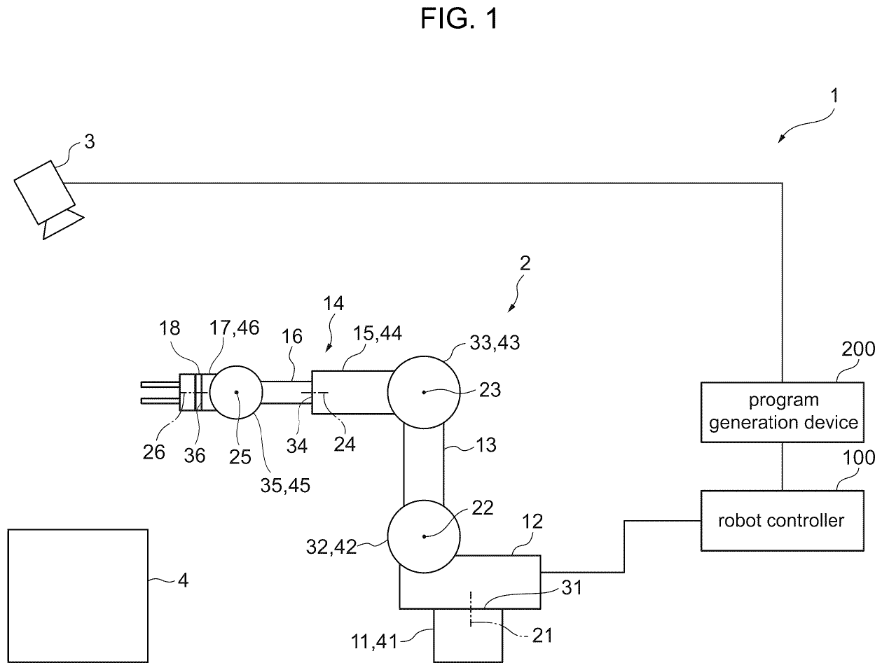

A robot system 1 illustrated in FIG. 1 is a system that causes a robot 2 to act based on a predetermined action program. For example, the robot system 1 is a system that causes the robot 2 to execute an action related to production of a workpiece or other tasks in an industrial field. It is also possible that the robot system 1 is a system that causes the robot 2 to execute an action in a field other than industry. As illustrated in FIG. 1, the robot system 1 includes the robot 2, an environmental sensor 3, a robot controller 100, and a program generation device 200.

The robot 2 illustrated in FIG. 1 is a 6-axis vertical articulated robot, and has a base part 11, a swivel part 12, a first arm 13, a second arm 14, a third arm 17, a tip part 18, and actuators (41, 42, 43, 44, 45, 46). The base part 11 is installed on a floor, wall, or ceiling, or an automated guided vehicle, or the like. The swivel part 12 is provided on the base part 11 so as to swivel around a vertical axis 21. The first arm 13 is connected to the swivel part 12 so as to swing around an axis 22 that intersects (for example, is perpendicular to) the axis 21 and extends in a direction away from the axis 22. The intersection also includes a case of a twisted relationship such as a so-called three-dimensional intersection. The same applies hereinafter.

The second arm 14 is connected to a tip part of the first arm 13 so as to swing around an axis 23 that is substantially parallel to the axis 22 and extends in a direction away from the axis 23. The second arm 14 includes an arm base part 15 and an arm end part 16. The arm base part 15 is connected to a tip part of the first arm 13. The arm end part 16 is connected to a tip part of the arm base part 15 so as to swivel around an axis 24 that intersects (for example, is perpendicular to) the axis 23, and extends in a direction away from the arm base part 15 along the axis 24.

The third arm 17 is connected to a tip part of the arm end 16 so as to swing around an axis 25 that intersects (for example, is perpendicular to) the axis 24. The tip part 18 is connected to a tip part of the third arm 17 so as to swivel around an axis 26 that intersects (for example, is perpendicular to) the axis 25.

In this way, the robot 2 has a joint 31 connecting the base part 11 and the swivel part 12, a joint 32 connecting the swivel part 12 and the first arm 13, a joint 33 connecting the first arm 13 and the second arm 14, a joint 34 connecting the arm base part 15 and the arm end part 16 in the second arm 14, a joint 35 connecting the arm end 16 and the third arm 17, and a joint 36 connecting the third arm 17 and the tip part 18.

The actuators (41, 42, 43, 44, 45, 46) each include, for example, an electric motor and a speed reducer, and respectively drive the joints (31, 32, 33, 34, 35, 36). For example, the actuator 41 rotates the swivel part 12 around the axis 21, the actuator 42 swings the first arm 13 around the axis 22, the actuator 43 swings the second arm 14 around the axis 23, the actuator 44 rotates the arm end part 16 around the axis 24, the actuator 45 swings the third arm 17 around the axis 25, and the actuator 46 rotates the tip part 18 around the axis 26.

The specific structure of the robot 2 can be modified as appropriate. For example, the robot 2 may be a 7-axis redundant robot that adds one more joint to the robot system in addition to the above 6-axis vertical articulated robot, or it may be a so-called SCARA-type multi-joint robot.

The environmental sensor 3 generates positional actual measurement data of the robot 2 and surrounding objects 4 of the robot 2, based on a camera image or the like. The surrounding objects 4 include stationary objects fixed in a work area and non-stationary objects that move within the work area. Specific examples of stationary objects include processing devices, workbenches, and the like. Specific examples of non-stationary objects include other robots, automated guided vehicles, workpieces, or the like.

The robot controller 100 causes the robot 2 to act based on a predetermined action program. The program generation device 200 generates the action program based on a user operation. When generating an action program, the program generation device 200 is structured to execute: generating a skill and storing the skill in a skill database, the skill representing a relative action; generating a task and storing the task in a task database, the task including multiple skills and associating each of the multiple skills with action reference coordinates that serve as a reference for the relative action; and generating a master and storing the master in a master database, the master including multiple tasks and associating the multiple tasks with the robot 2.

Since a skill that defines an action is represented by a relative action, the skill can be reused with respect to any action reference coordinates. Therefore, a task can be flexibly structured by a combination of a skill and action reference coordinates. Since a task associates a relative action of a skill with action reference coordinates without limiting an executing entity, a task also can be reused with respect to any executing entity. Therefore, a master can be flexibly constructed by a combination of a task and an executing entity. Consequently, this is effective for improving efficiency of action program generation.

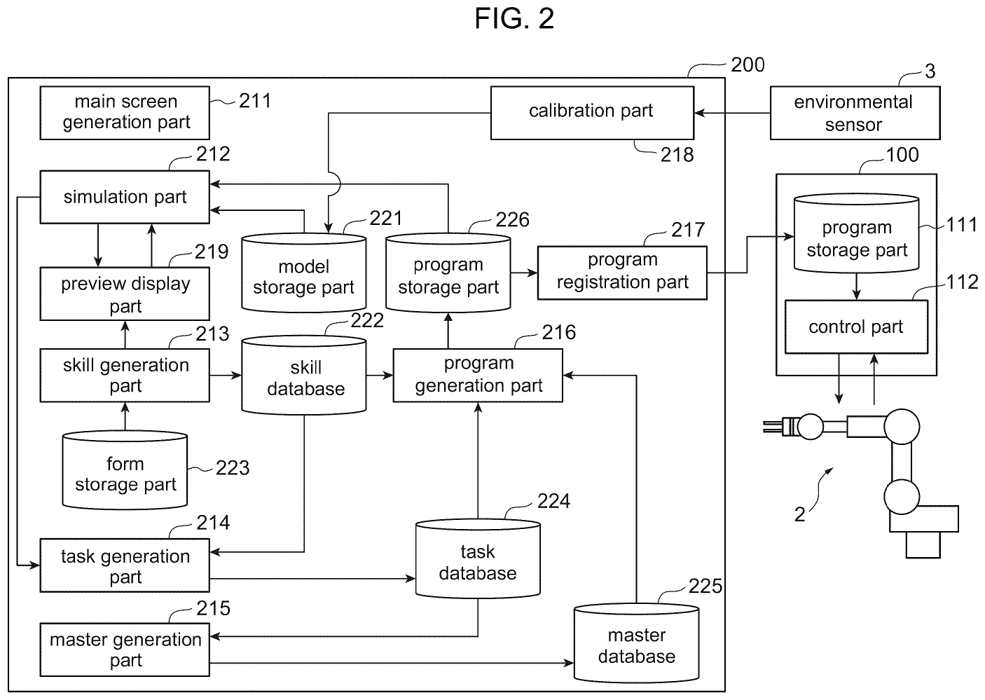

FIG. 2 is a block diagram illustrating an example of functional structures of the robot controller 100 and the program generation device 200. As illustrated in FIG. 2, the robot controller 100 has, as functional structural elements (hereinafter referred to as “functional blocks”), a program storage part 111 and a control part 112. The program storage part 111 stores the action program. The action program includes multiple action commands in a time series. The multiple action commands each define at least a target position of the tip part 18 and an action speed of the tip part 18 to reach the target position.

The target position is information that defines coordinates of the tip part 18 in a robot coordinate system and orientation of the tip part 18 around each coordinate axis. The robot coordinate system is a three-dimensional coordinate system fixed to the base part 11. The target position of the tip part 18 may be information that directly defines the coordinates and orientation of the tip part 18, or it may be information that indirectly defines the coordinates and orientation of the tip part 18. Specific examples of information that indirectly define the coordinates and orientation of the tip part 18 include rotation angles of the joints (31, 32, 33, 34, 35, 36).

The control part 112 sequentially calls up the multiple action commands stored in the program storage part 111 and causes the robot 2 to act based on the action commands. For example, the control part 112 repeats a control process at a constant control cycle. The control process includes calculating a target angle for each of the joints (31, 32, 33, 34, 35, 36) for moving the tip part 18 along an action path represented by the target positions of the multiple action commands and causing an angle of each of the joints (31, 32, 33, 34, 35, 36) to follow the target angle.

The program generation device 200 has, as functional blocks, a simulation part 212, a main screen generation part 211, a skill generation part 213, a task generation part 214, a master generation part 215, a program generation part 216, and a program registration part 217. The simulation part 212 executes a simulation that includes a model of the robot 2 and models of the surrounding objects 4 of the robot 2. The simulation means to computationally emulate a state of a real space where the robot 2 and the surrounding objects 4 are positioned.

For example, the simulation part 212 executes a simulation based on three-dimensional model data stored in a model storage part 221. The three-dimensional model data stored in the model storage part 221 includes three-dimensional model data of the robot 2 and three-dimensional model data of the surrounding objects 4 of the robot 2. The model storage part 221 may be provided in a storage device of the program generation device 200, or in an external storage device capable of communicating with the program generation device 200.

The main screen generation part 211 generates a main screen for acquiring a user operation. For example, the main screen generation part 211 displays the main screen on a user interface 295 to be described below. The skill generation part 213 generates skills that respectively represent relative actions and stores the skills in a skill database 222. For example, when skill generation is requested by an input on the main screen, the skill generation part 213 generates a skill generation screen for generating a skill, generates a skill based on an input on the skill generation screen, and stores the skill in the skill database 222. The skill database 222 may be provided in the storage device of the program generation device 200, or in an external storage device capable of communicating with the program generation device 200.

A relative action means a relative change in the position and orientation of the tip part 18 with respect to the action reference coordinates. Even when a relative action is defined, an action of the tip part 18 in a three-dimensional space is not defined unless the action reference coordinates are defined.

The skill generation part 213 may generate a skill that includes at least a start position and an end position of a relative action. Since a start position and an end positions are defined as a relative action, the robot 2 can be moved with respect to a master that arranges tasks that connect skills. The start position and the end position are relative positions with respect to the action reference coordinates, and the start position and the end position are not defined unless the action reference coordinates are defined.

The skill generation part 213 may generate a skill that includes an approach action from the start position to a work start position and a depart action from a work end position to the end position. By including an approach action and a depart action in a skill, usability of the skill in task generation can be improved.

For example, the skill generation part 213 generates a skill that includes one or more approach action commands representing an approach action, and one or more depart action commands representing a depart action. The one or more approach action commands each include at least a target position of the tip part 18 expressed as a relative value with respect to the action reference coordinates, and a target speed of the tip part 18 to reach the target position.

The skill generation part 213 may generate a skill further including a main action from a work start position to a work end position. For example, the skill generation part 213 generates a skill that includes one or more main action commands representing a main action. The one or more main action commands each include a target position of the tip part 18 expressed in a relative value with respect to the action reference coordinates, and a target speed of the tip part 18 to reach the target position. A program module including the one or more main action commands may be generated separately from the skill. In this case, the skill may include a module call command that calls the program module instead of the one or more main action commands. When a skill includes a module call command, a program module is referenced when an action program is generated based on the skill, or when the robot 2 is caused to act based on the skill.

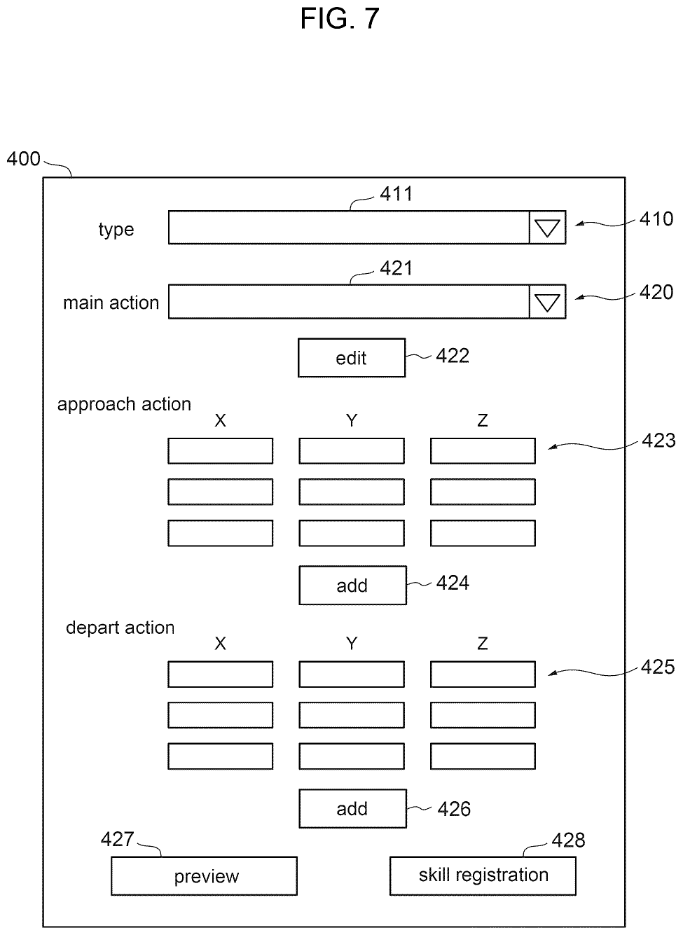

The skill generation part 213 may generate a skill generation screen that allows separate input of a main action, an approach action, and a depart action (see FIG. 7).

The skill generation part 213 may generate a skill by extracting at least a part of a generated action program and converting it into a relative action. The action program may be an action program previously generated by the program generation device 200, or it may be an action program generated by manual teaching with respect to the robot controller 100.

For example, the skill generation part 213 acquires a section specification that specifies a target section of a portion of the action program, and a coordinate specification that specifies the action reference coordinates for the section. The skill generation part 213 generates a skill by converting target positions of one or more action commands of the target section into relative positions with respect to the action reference coordinates specified by the coordinate specification. In this way, it allows a generated action program to be effectively utilized as a skill that can be applied with respect to any action reference coordinates.

The skill generation part 213 may generate a type input interface on the skill generation screen that allows an input of a skill type, generate a skill input interface on the skill generation screen corresponding to the skill type based on an input to the type input interface, and generate a skill based on an input to the skill input interface. This can prompt the user to provide an appropriate input.

For example, the skill generation part 213 generates a skill input interface corresponding to a skill type by referring to a form storage part 223. The form storage part 223 stores multiple types of input forms in association with multiple skill types. The form storage part 223 may be provided in the storage device of the program generation device 200, or in an external storage device capable of communicating with the program generation device 200.

The action program can also include a computation command such as a parameter setting in addition to one or more action commands. Correspondingly, the skill generation part 213 may generate a skill that includes one or more computation commands. The skill generation part 213 may generate a skill that includes only one or more computation commands. One or more computation commands alone do not allow a relative action of the robot 2 to occur. Therefore, as an example of a relative action of the robot 2, a skill that includes only one or more computation commands corresponds to a skill that represents that a relative position with respect to the action reference coordinates does not change.

The task generation part 214 generates a task and stores the task in a task database 224. A task includes multiple skills and associates each of the multiple skills with action reference coordinates that serve as a reference for a relative action. For example, when task generation is requested by an input on the main screen, the task generation part 214 generates a task generation screen for generating a task, generates a task based on an input on the task generation screen, and stores the task in the task database 224. The task database 224 may be provided in the storage device of the program generation device 200, or in an external storage device capable of communicating with the program generation device 200.

On the task generation screen, it is possible to input a task flow in which any skills are arranged in an execution order, and to associate any action reference coordinates with each of the multiple skills included in the task flow. The task generation part 214 generates a task that includes multiple skills included in a task flow, action reference coordinates for each of the multiple skills, and an execution order of the multiple skills.

Examples of multiple skills included in a task flow include a pick skill for grasping a workpiece before transport, and a place skill for arranging and releasing the workpiece at a destination. The pick skill is associated with action reference coordinates fixed at a position of the workpiece before transport. The place skill is associated with action reference coordinates fixed at a position of the workpiece after transport.

The multiple skills included in a task are those stored in the skill database 222 by the skill generation part 213. However, the generation of the task by the task generation part 214 and the generation of the multiple skills by the skill generation part 213 can occur in either order. For example, the task generation part 214 may generate the task after the skill generation part 213 has generated the multiple skills. The skill generation part 213 may generate the multiple skills after the task generation part 214 has generated the task.

The action reference coordinates include a position of an origin. The position of the origin is expressed, for example, as coordinates in a common coordinate system of the robot system 1 fixed in a workspace of the robot 2. At the time of task generation, the position of the origin may be a variable. In this case, by inputting the position of the origin as a variable at the time of task execution (the time of executing an action program generated based on a task), based on a position of a workpiece detected by the environmental sensor 3 and other factors, it becomes possible to adapt the task in real-time to the position of the workpiece. The position of the origin does not necessarily need to be acquired from the environmental sensor 3 but may be acquired from an upper-level controller that communicates with multiple local controllers including the robot controller 100.

The task generation part 214 may generate a task that associates one or more parameters that define a variable action in a relative action with one or more skills. For example, the task generation part 214 may generate a parameter input part for inputting one or more parameters on the task generation screen or on a separate screen from the task generation screen, and, based on an input to the parameter input part, associates one or more parameters with each of one or more skills.

A variable action in a relative action can change depending on positioning of a skill within a task. By enabling association of one or more parameters with a skill in a task generation stage, it becomes easier to adapt a variable action to a task.

A variable action is an action that changes depending on values of one or more parameters. An example of a variable action is a bolt-tightening action, and examples of one or more parameters for the bolt-tightening action include a bolt diameter, a tightening torque, and the like. The bolt diameter, the tightening torque, and the like can vary depending on a work target site of the bolt-tightening action. The work target site (action reference coordinates) of the bolt-tightening action is determined by a task. Since it is possible to associate the bolt diameter and the tightening torque with a skill in a task generation stage, the bolt-tightening action can be easily adapted to the work target site.

The task generation part 214 may associate action reference coordinates with each of multiple skills based on an input specifying coordinates in a simulation. For example, the task generation part 214 may display a simulation image of the robot 2 and the surrounding objects 4 generated by the simulation part 212, and associate action reference coordinates selected by the user in the simulation image with each of multiple skills. Action reference coordinates to be associated with a skill can be easily specified.

The master generation part 215 generates a master and stores the master in a master database 225. A master includes multiple tasks and associates the robot 2 with the multiple tasks. For example, when master generation is requested by an input on the main screen, the master generation part 215 generates a master generation screen for generating a master, generates a master based on an input on the master generation screen, and stores the master in the master database 225. The master database 225 may be provided in the storage device of the program generation device 200, or in an external storage device capable of communicating with the program generation device 200.

On the master generation screen, it is possible to input a master flow in which any tasks are arranged in an execution order, and to associate any robot 2 with the master flow. The master generation part 215 generates a master that includes multiple tasks included in a master flow, identification information of the robot 2 associated with the master flow, and an execution order of the multiple tasks.

The master generation part 215 may generate a master that associates a start condition with one or more tasks. In this case, on the master generation screen, it is possible to input a master flow in which any tasks and wait processes of waiting for start conditions to be met are arranged in an execution order. Based on the master flow, the master generation part 215 generates a master that further includes wait processes. A more advanced action program including determination of a start condition can be easily generated.

The master generation part 215 may generate a master that includes a conditional branching between two or more tasks. A conditional branching means that a master flow branches into two or more streams depending on whether or not a branching condition is met. The master includes a branch determination process that determines whether or not a branching condition is met, and two or more execution orders corresponding to the two or more streams.

When it is possible to generate a master that includes a conditional branching, on the master generation screen, it is possible to input a master flow that further includes a branch determination process and branches into two or more streams in the branch evaluation process. Based on the master flow, the master generation part 215 generates a master that includes the branch determination process and two or more execution orders corresponding to the two or more streams.

Two or more skills with a fixed execution order can be grouped into a single task, and a conditional branching between two or more tasks that depend on an executing entity or the like can be set in a concentrated manner in a master generation stage. Therefore, an action program can be more easily generated.

The master generation part 215 may generate a master that associates a notification destination for an execution status by the robot 2 with one or more tasks. For example, the master generation part 215 generates a notification destination input part for inputting an execution status notification destination on the master generation screen or on a separate screen from the master generation screen, and, based on an input to the notification destination input part, associates an execution status notification destination with each of one or more tasks.

Examples of execution status notifications include notifications of execution start and execution completion. Examples of notification destinations include a signal output port from the robot controller 100 to a host controller, and the like. Coordination with a host controller is a matter to be considered at the master generation stage where an executing entity is determined. By enabling association of an execution status notification destination with one or more tasks in the master generation stage, an action program that includes coordination with a host controller can be easily generated.

The program generation part 216 generates an action program for the robot 2 in which a relative action is converted into an action of the robot 2, based on a master, multiple tasks included in the master, and multiple skills included in each of the multiple tasks. For example, when program generation is requested by an input on the master generation screen or another screen, the program generation part 216 generates an action program.

For example, based on association between multiple tasks in a master and the robot 2 and association between multiple skills in each of the multiple tasks and multiple sets of action reference coordinates, the program generation part 216 generates an action program by converting a relative action of each of the multiple skills into an action in the robot coordinate system fixed to the robot 2. For example, the program generation part 216 generated an action program in which target positions of one or more action commands (for example, the approach action command, main action command, and depart action command describe above) included in each of multiple skills are converted into target positions in the robot coordinate system, and the target positions of all the action commands are expressed in the robot coordinate system. An action of the robot 2 specified by skills, tasks, and a master can be easily applied to an existing robot controller 100 that acts based on an action program expressed in the robot coordinate system.

The program generation part 216 stores the generated action program in a program storage part 226. The program storage part 226 may be provided in a storage device of the program generation device 200, or in an external storage device capable of communicating with the program generation device 200.

Based on skills, tasks, and a master, it is also possible to perform execution by sequentially converting target positions of one or more action commands included in each of the multiple skills into target positions in the robot coordinate system. In this way, when the robot controller 100 executes sequential conversion of target positions based on skills, tasks, and a master, it is not necessary to generate an action program by the program generation part 216.

The master generation part 215 may generate a master by associating multiple tasks to be executed with respect to a workpiece of the robot system 1 with multiple executing entities including the robot 2. In this case, the program generation part 216 may generate an action program for each of the multiple executing entities based on the association in the master. When multiple tasks to be executed with respect to a workpiece of the robot system 1 are consolidated into a master of the robot system 1, an action program can be generated by allocating the multiple tasks to multiple executing entities. Therefore, it becomes easier to generate an action program with a workpiece-centric approach.

The program generation part 216 may generate an action program that includes an air cut program for causing the robot 2 to act from an end position of an action of the robot 2 corresponding to a relative action of a preceding skill to a start position of an action of the robot 2 corresponding to a relative action of a subsequent skill, in consecutive skills. According to the program generation part 216 that generates an action program based on skills, tasks, and a master, it becomes possible to easily generate an air cut program with a determined executing entity from a skill of which an executing entity is not yet determined.

For example, the program generation part 216 generates an air cut program such that the robot 2 does not interfere with the surrounding objects 4 and the robot 2 itself. The program generation part 216 linearly interpolates an end position and a start position to provisionally generate an air cut path and causes the control part 112 to simulate an action of the robot 2 based on the provisionally generated air cut path. When, as a result of the simulation, it is determined that the robot 2 will interfere with the surrounding objects 4 or the robot 2 itself, the program generation part 216 randomly generates an intermediate position that does not interfere with the surrounding objects 4 and the robot 2 itself and adds the intermediate position between the end position and the start position. After that, generation and addition of an intermediate position are repeated until the robot 2 does not interfere with the surrounding objects 4 and the robot 2 itself using an air cut action path connecting the end position, one or more generated intermediate positions, and the start position. After that, the program generation part 216 generates an air cut program that includes two or more air cut action commands with the one or more added intermediate positions and the start position as their respective target positions.

The master generation part 215 may further generate an upper-level master that includes a conditional branching between multiple masters and store the upper-level master in the master database 225. Here, the conditional branching means branching into multiple master flows that respectively correspond to multiple masters, depending on whether or not a branching condition is met. The upper-level master includes a branch determination process that determines whether or not a branching condition is met, and multiple branches that respectively connect to multiple master flows. An example of a conditional branching in an upper-level master is a conditional branching according to workpiece types between multiple masters that are respectively generated corresponding to multiple workpiece types.

When the master generation part 215 further generates an upper-level master, the program generation part 216 generates an action program for the robot 2 in which a relative action is converted into an action of the robot 2, based on the upper level master, multiple masters, multiple tasks included in each of the masters, and multiple skills included in each of the multiple tasks.

When program registration is requested by an input on the master generation screen or another screen, the program registration part 217 transmits the action program stored in the program storage part 226 to the robot controller 100 and registers the action program in the program storage part 111 of the robot controller 100.

The program generation device 200 may further have a calibration part 218. The calibration part 218 corrects the action reference coordinates based on a difference between actual measurement data of the surrounding objects 4 and a model of the surrounding objects 4. For example, when calibration is requested by an input on the master generation screen or another screen, the calibration part 218 acquires positional actual measurement data of the surrounding objects 4 from the environmental sensor 3. The calibration part 218 calculates a difference between the acquired actual measurement data and a position of the model of the surrounding objects 4 in the model storage part 221 and corrects the model in the model storage part 221 to eliminate the difference. When the model in the model storage part 221 is corrected, for example, the simulation part 212 notifies the task generation part 214 of details of the correction. Based on the notified details of the correction, the task generation part 214 corrects the action reference coordinates associated with each of multiple skills in the task database 224. In this way, by applying the difference between the actual measurement data and the model to the action reference coordinates, an action of the robot 2 can be easily adapted to a real environment.

A method for acquiring positional actual measurement data of the surrounding objects 4 is not limited to a method using the environmental sensor 3. For example, in a state where the tip part 18 is positioned at a position of the surrounding objects 4, the calibration part 218 may acquire a position of the tip part 18 in the robot coordinate system as actual measurement data of the position of the surrounding objects 4.

When action reference coordinates are corrected by the task generation part 214, the program generation part 216 may regenerate the action program based on the corrected action reference coordinates and store the action program in the program storage part 226. Regenerating the action program includes correcting a generated action program based on details of the correction of the action reference coordinates.

The program generation device 200 may further have a preview display part 219. The preview display part 219 associates a provisional robot 2 and provisional action reference coordinates with a skill generated by the skill generation part 213 and displays a simulation of a case where the provisional robot 2 executes the skill at the provisional action reference coordinates. For example, when a preview display of a skill is requested by an input on the skill generation screen or another screen, the preview display part 219 generates a preview interface on the skill generation screen or another screen for specifying a provisional robot 2 and provisional action reference coordinates. Based on an input to the preview interface, the preview display part 219 associates a provisional robot 2 and provisional action reference coordinates with a skill and causes the control part 112 to simulate an action of the provisional robot 2 executing the skill with respect to the provisional action reference coordinates. The control part 112 generates a simulation video of an action of the provisional robot 2 executing the skill with respect to the provisional action reference coordinates and displays the video on the skill generation screen or another screen. This allows skills to be generated while sequentially confirming actions of the skills.

### Hardware Structures

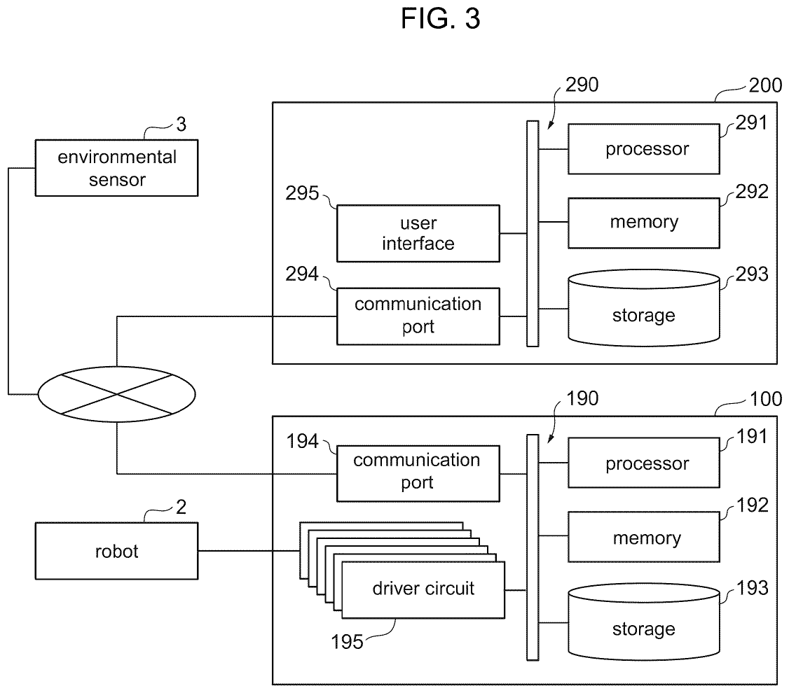

FIG. 3 is a block diagram illustrating an example of hardware structures of the robot controller 100 and the program generation device 200. The robot controller 100 has a circuit 190. The circuit 190 has one or more processors 191, one or more memory devices 192, one or more storage devices 193, a communication port 194, and a driver circuit 195. The one or more storage devices 193 are non-volatile storage media that store programs for causing the functional blocks described above to be provided in the robot controller 100. The one or more storage devices 193 may each be an internal storage medium such as a flash memory or a hard disk, or may each be a portable storage medium such as a USB memory or an optical disc.

The one or more memory devices 192 temporarily store programs loaded from the one or more storage devices 193. The one or more memory devices 192 may each be a random access memory or the like. The one or more processors 191 provide the functional blocks described above by executing the programs loaded in the one or more memory devices 192. The one or more processors 191 store computation results in the one or more memory devices 192 as appropriate.

The communication port 194 communicates with the program generation device 200 based on a request from the one or more processors 191. The driver circuit 195 supplies drive power to the robot 2 (the actuators (41, 42, 43, 44, 45, 46)) based on a request from the one or more processors 191.

The program generation device 200 has a circuit 290. The circuit 290 has one or more processors 291, one or more memory devices 292, one or more storage devices 293, a communication port 294, and a user interface 295. The one or more storage devices 293 are non-volatile storage media and store programs for causing the program generation device 200 to execute: generating a skill representing a relative action and saving the skill in the skill database; generating a task that includes multiple skills and associates action reference coordinates, which serve as a reference for a relative action, with each of the multiple skills, and saving the task in the task database; and generating a master that includes multiple tasks and associates the robot 2 with the multiple tasks, and saving the master in the master database. For example, the one or more storage devices 293 store programs for causing the functional blocks described above to be provided in the program generation device 200. The one or more storage devices 293 may each be an internal storage medium such as a flash memory or a hard disk, or may each be a portable storage medium such as a USB memory or an optical disc.

The one or more memory devices 292 temporarily store programs loaded from the one or more storage devices 293. The one or more memory devices 292 may each be a random access memory or the like. The one or more processors 291 provide an operation interface by executing the programs loaded into the one or more memory devices 292. The one or more processors 291 store computation results in the one or more memory devices 292 as appropriate.

The communication port 294 communicates with the robot controller 100 based on a request from the one or more processors 291. The user interface 295 communicates with an operator (user) based on a request from the one or more processors 291. For example, the user interface 295 includes a display device and an input device. Examples of the display device include a liquid crystal monitor, an organic EL (Electro-Luminescence) monitor, and the like. Examples of the input device include a keyboard, a mouse, a keypad, and the like. The input device may be integrated with the display device as a touch panel.

The hardware structures described above are merely examples and can be modified as appropriate. For example, the program generation device 200 may be incorporated into the robot controller 100. Further, the program generation device 200 may also be formed of multiple devices that can communicate with each other.

### Program Generation Procedure

Next, as an example of a program generation method, a program generation procedure executed by the program generation device 200 is illustrated. This procedure includes: the skill generation part 213 generates a skill representing a relative action and stores the skill in the skill database 222; the task generation part 214 generates a task that includes multiple skills and associates action reference coordinates, which serve as a reference for a relative action, with each of the multiple skills, and stores the task in the task database 224; and the master generation part 215 generates a master that includes multiple tasks and associates the robot 2 with the multiple tasks, and stores the master in the master database 225.

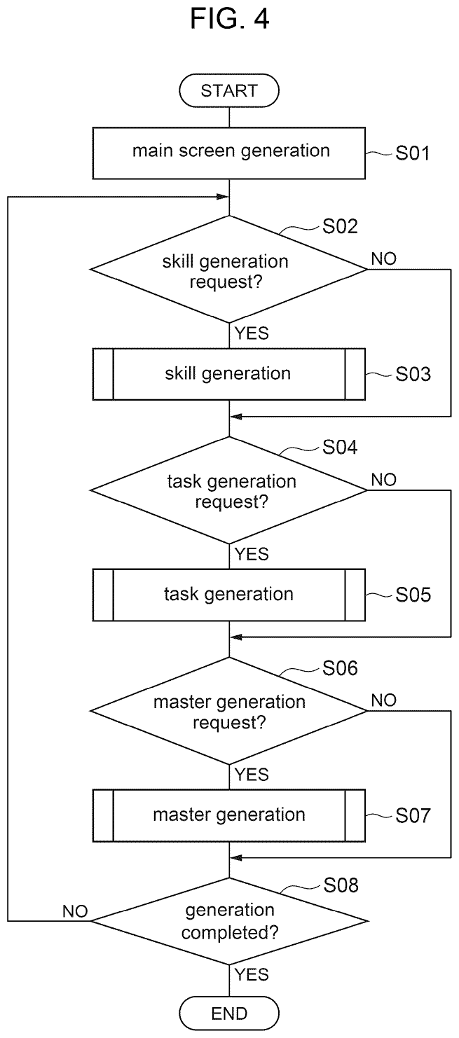

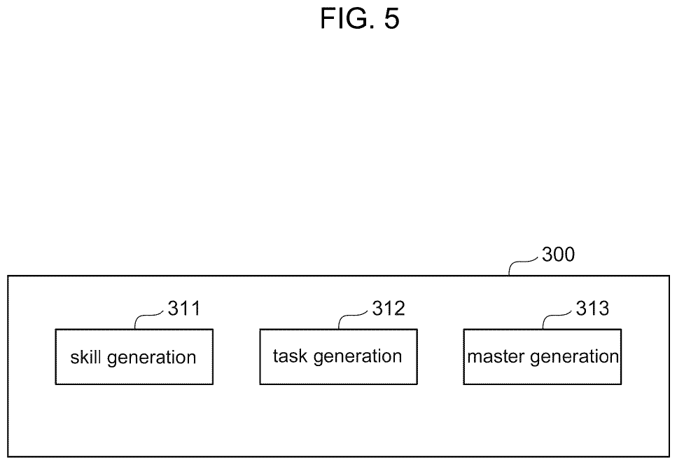

As illustrated in FIG. 4, the program generation device 200 first executes S01. In S01, the main screen generation part 211 displays the main screen described above on the user interface 295. FIG. 5 is a schematic diagram illustrating an example of the main screen. A main screen 300 illustrated in FIG. 5 includes a skill generation button 311, a task generation button 312, and a master generation button 313. The skill generation button 311 is a button for requesting generation of a skill. The task generation button 312 is a button for requesting generation of a task. The master generation button 313 is a button for requesting generation of a master.

Returning to FIG. 4, the program generation device 200 next executes S02. In S02, the skill generation part 213 confirms whether or not generation of a skill has been requested. For example, the skill generation part 213 confirms whether or not the skill generation button 311 has been pressed. When it is determined in S02 that generation of a skill has been requested, the program generation device 200 executes S03. In S03, the skill generation part 213 executes a skill generation process. Details of S03 will be described later.

Next, the program generation device 200 executes S04. When it is determined in S02 that generation of a skill has not been requested, the program generation device 200 executes S04 without executing S03. In S04, the task generation part 214 confirms whether or not generation of a task has been requested. For example, the task generation part 214 confirms whether or not the task generation button 312 has been pressed. When it is determined in S04 that generation of a task has been requested, the program generation device 200 executes S05. In S05, the task generation part 214 executes a task generation process. Details of S05 will be described later.

Next, the program generation device 200 executes S06. When it is determined in S04 that generation of a task has not been requested, the program generation device 200 executes S06 without executing S05. In S06, the master generation part 215 confirms whether or not generation of a master has been requested. For example, the master generation part 215 confirms whether or not the master generation button 313 has been pressed. When it is determined in S06 that generation of a master has been requested, the program generation device 200 executes S07. In S07, the master generation part 215 executes a master generation process. Details of S07 will be described later.

Next, the program generation device 200 executes S08. In S08, the main screen generation part 211 confirms whether or not generation of skills, tasks, and masters has completed. For example, the main screen generation part 211 determines that generation of skills, tasks, and masters has completed when the main screen 300 is closed. When it is determined that generation of skills, tasks, and masters has not completed, the program generation device 200 returns the process to S02. After that, generation of a skill, a task, or a master is repeated according to a request until generation of skills, tasks, and masters has completed.

In the following, the details of each of the skill generation process in S03, the task generation process in S05, and the master generation process in S07 are illustrated.

### Skill Generation Process

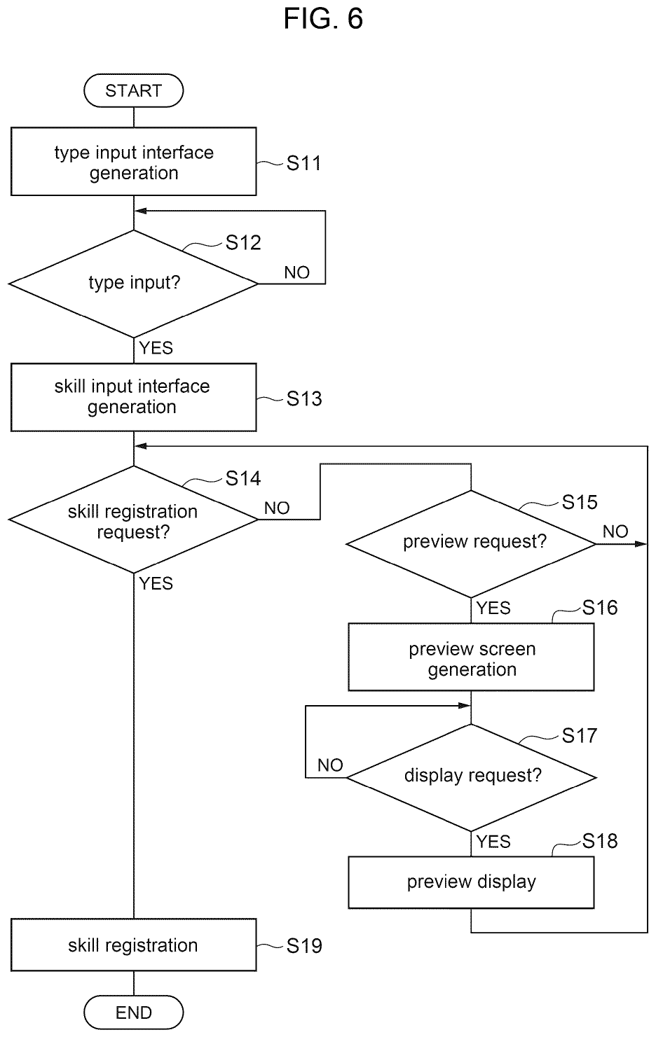

FIG. 6 is a flowchart illustrating an example of a skill generation procedure. As illustrated in FIG. 6, the program generation device 200 first executes S11 and S12. In S11, the skill generation part 213 generates the type input interface described above for inputting a skill type, and displays the skill generation screen including the type input interface on the user interface 295. In S12, the skill generation part 213 waits for an input of a type to the type input interface.

Next, the program generation device 200 executes S13. In S13, the skill generation part 213 generates a skill input interface in the skill generation screen according to the skill type.

FIG. 7 is a schematic diagram illustrating an example of a skill generation screen including a type input interface and a skill input interface. A skill generation screen 400 illustrated in FIG. 7 includes a type input interface 410 and a skill input interface 420. The type input interface 410 includes a type list box 411. The type list box 411 is an interface for inputting a skill type by selecting one of types displayed in a drop-down list.

The skill input interface 420 changes according to the skill type input in the type list box 411. FIG. 7 illustrates an example of the skill input interface 420 in a case where a type requiring input of the main action, the approach action, and the depart action is input in the type list box 411. The skill input interface 420 includes a main action list box 421, an edit button 422, an intermediate position input box 423, an add button 424, an intermediate position input box 425, an add button 426, a preview button 427, and a skill registration button 428. The main action list box 421 is an interface for inputting the main action to be included in the skill by selecting one of the main actions displayed in a drop-down list.

The main action list includes multiple pre-generated main actions. The multiple main actions may each be generated based on a simulation or based on a generated action program. When a main action is input into the main action list box 421, the skill generation part 213 reads in one or more main action commands representing the input main action.

The edit button 422 is a button for requesting display of a main action edit screen. When the edit button 422 is pressed, the skill generation part 213 displays an edit screen containing one or more main action commands representing the main action selected in the main action list box 421, and modifies the main action based on an input to the edit screen. When the edit button 422 is pressed without a main action being selected in the main action list box 421, the skill generation part 213 may display a blank edit screen and generate a new main action based on an input to the edit screen.

The intermediate position input box 423 is an input box for inputting one or more intermediate positions for the approach action. The skill generation part 213 interprets an intermediate position input to the intermediate position input box 423 as a relative position with respect to the action reference coordinates. The intermediate position input box 423 is structured to allow individual input of X, Y and Z coordinates of an intermediate position in the action reference coordinates. The add button 424 is a button for requesting an addition of an intermediate position input box 423. When the add button 424 is pressed, the skill generation part 213 adds an intermediate position input box 423 to the skill input interface 420. This allows the approach action to be represented with any number of intermediate positions. The skill generation part 213 may prohibit user input to the intermediate position input box 423 corresponding to the end position of the approach action and may automatically input the work start position of the main action to the intermediate position input box 423.

The intermediate position input box 425 is an input box for inputting one or more intermediate positions for the depart action. The skill generation part 213 interprets an intermediate position input to the intermediate position input box 425 as a relative position with respect to the action reference coordinates. The intermediate position input box 425 is structured to allow individual input of X, Y and Z coordinates of an intermediate position in the action reference coordinates. The add button 426 is a button for requesting an addition of an intermediate position input box 425. When the add button 426 is pressed, the skill generation part 213 adds an intermediate position input box 426 to the skill input interface 420. This allows the depart action to be represented with any number of intermediate positions. The skill generation part 213 may prohibit user input to the intermediate position input box 425 corresponding to the start position of the depart action and may automatically input the work end position of the main action to the intermediate position input box 425.

The preview button 427 is a button for requesting a preview display of a skill being generated. The skill registration button 428 is a button for requesting registration of a skill including an approach action, a main action, and a depart action.

As described above, the skill input interface 420 changes depending on the skill type input in the type list box 411. Therefore, the skill input interface 420 illustrated in FIG. 7 is merely an example. For example, the skill may include only one or more of the computation commands described above. In this case, the skill generation part 213 displays a skill input interface 420 that includes an input interface for computation content instead of input for the main action, the approach action, and the depart action.

Returning to FIG. 6, the program generation device 200 next executes S14. In S14, the skill generation part 213 confirms whether or not there is a skill registration request based on an input to the skill input interface. For example, the skill generation part 213 confirms whether or not the skill registration button 428 has been pressed.

When it is determined in S14 that there is no skill registration request, the program generation device 200 executes S15. In S15, the preview display part 219 determines whether or not there is a preview display request. For example, the preview display part 219 confirms whether or not the preview button 427 has been pressed. When it is determined in S15 that there is no preview display request, the program generation device 200 returns the process to S14. After that, input to the skill input interface is accepted until there is a skill registration request or a preview display request.

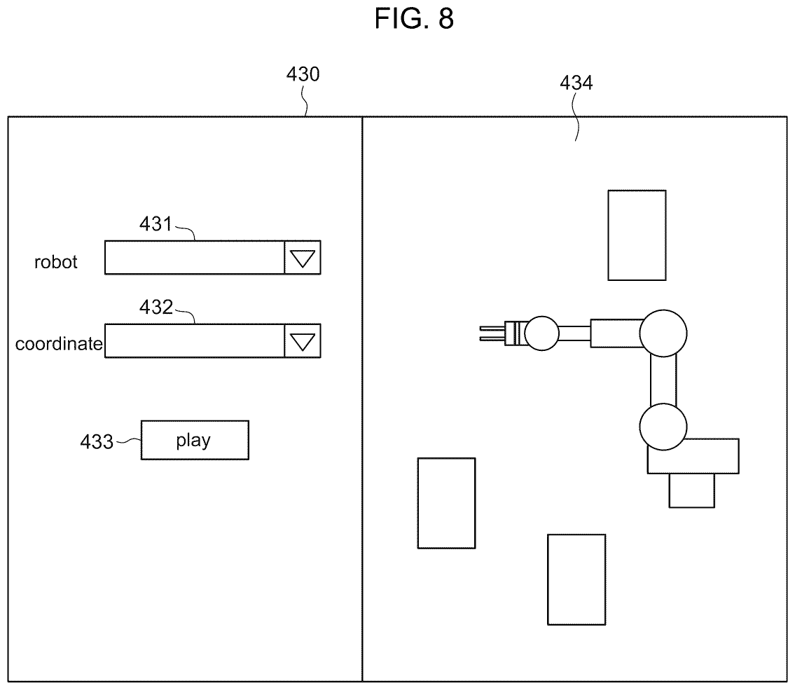

When it is determined in S15 that there is a preview display request, the program generation device 200 executes S16. In S16, the preview display part 219 generates a preview screen (preview interface) for previewing a skill. FIG. 8 is a schematic diagram illustrating an example of the preview screen. A preview screen 430 illustrated in FIG. 8 includes a robot list box 431, a coordinate list box 432, a play button 433, and a preview window 434.

The robot list box 431 is an interface for inputting a provisional robot 2 by selecting one of robots displayed in a drop-down robot list. The robot list includes multiple robots 2 that each can act as an executing entity for a skill. The coordinate list box 432 is an interface for inputting provisional action reference coordinates by selecting one of coordinates displayed in a drop-down coordinate list. The coordinate list includes multiple action reference coordinates that can be associated with skills. The play button 433 is a button for requesting execution of preview display. The preview window 434 is a window for displaying a simulation of a case where the provisional robot 2 executes a skill at the provisional action reference coordinates.

Returning to FIG. 6, the program generation device 200 next executes S17. In S17, the preview display part 219 waits for a request to execute a preview display. For example, the preview display part 219 waits for the play button 433 to be pressed. When it is determined in S17 that there is a request to execute a preview display, the program generation device 200 executes S18.

In S18, the preview display part 219 associates a provisional robot 2 and provisional action reference coordinates with a skill based on an input to the preview interface and causes the simulation part 212 to simulate an action of the provisional robot 2 executing the skill with respect to the provisional action reference coordinates. The preview display part 219 may associate provisional action reference coordinates with a skill based on an input specifying coordinates in a simulation, instead of an input to the coordinate list box 432. For example, the preview display part 219 may associate provisional action reference coordinates with a skill based on an input specifying coordinates in a simulation image of the preview window 434. The simulation part 212 generates a simulation video of an action of a provisional robot 2 executing a skill with respect to provisional action reference coordinates and displays the video on the skill generation screen or another screen. For example, the simulation part 212 displays the simulation video in the preview window 434. After that, the program generation device 200 returns the process to S14.

When it is determined in S14 that there is a skill registration request, the program generation device 200 executes S19. In S19, the skill generation part 213 stores a skill in the skill database 222 based on an input to the skill input interface and closes the skill generation screen.

### Task Generation Process

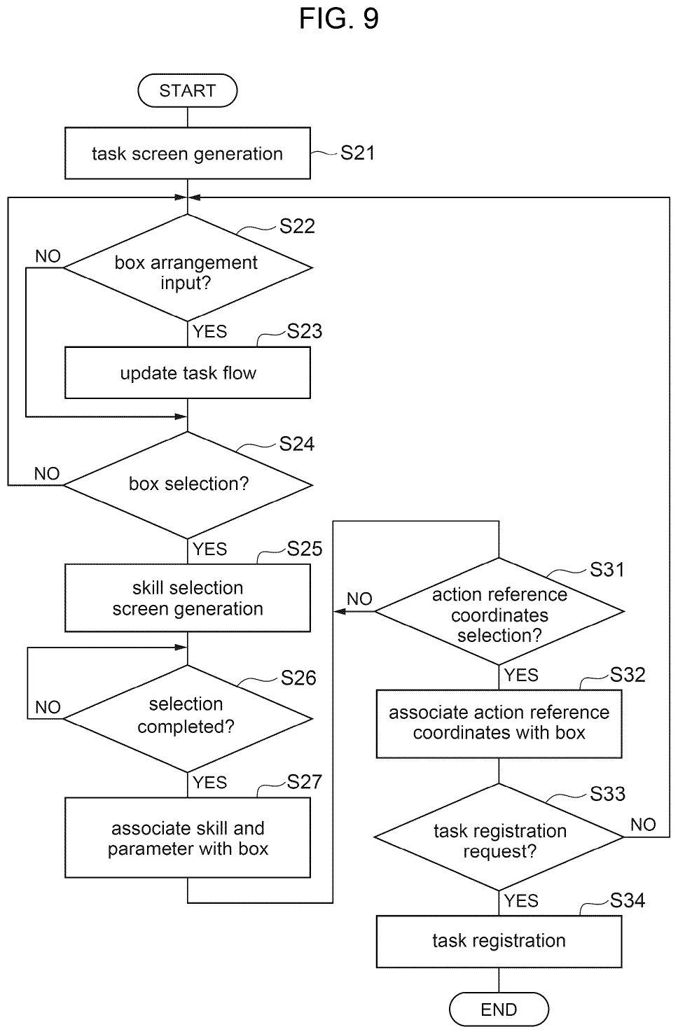

FIG. 9 is a flowchart illustrating an example of a task generation procedure. As illustrated in FIG. 9, the program generation device 200 first executes S21. In S21, the task generation part 214 displays the task generation screen described above on the user interface 295.

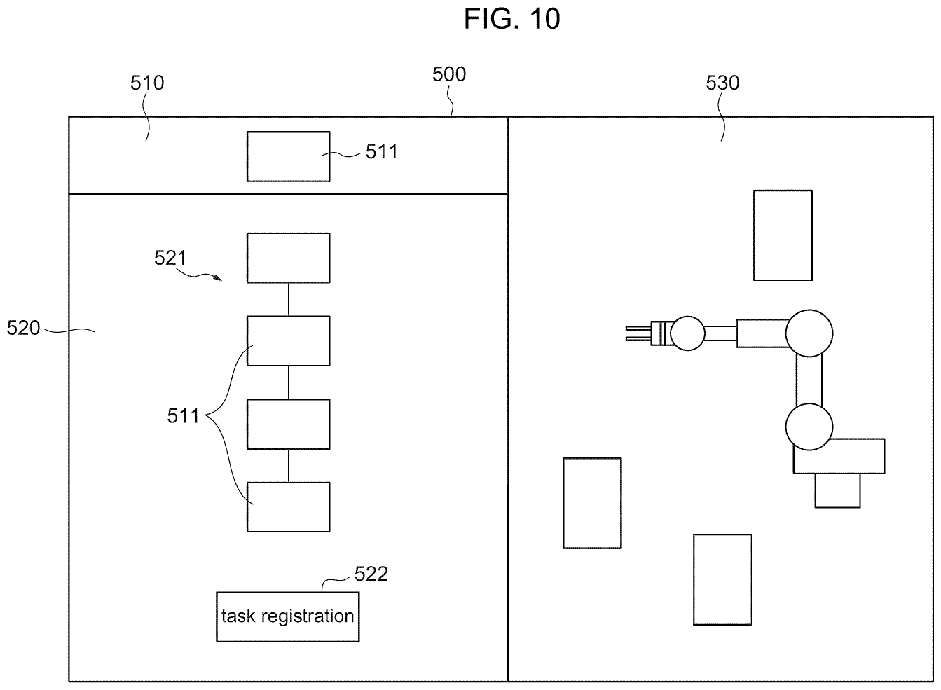

FIG. 10 is a schematic diagram illustrating an example of the task generation screen. A task generation screen 500 illustrated in FIG. 10 includes an item window 510, a flow window 520, and a simulation window 530. The item window 510 is a window that displays items for generating the task flow described above. As an example, the item window 510 includes a skill box 511 that represents skills of the robot system 1. The flow window 520 is a window for inputting a task flow 521. As an example, by dragging the skill box 511 from the item window 510 to the flow window 520, multiple skill boxes 511 can be positioned in the flow window 520 in an execution order, and thereby, the task flow 521 can be drawn in the flow window 520. The flow window 520 includes a task registration button 522. The task registration button 522 is a button for requesting registration of a task represented by a task flow. The simulation window 530 is a window for displaying a simulation image showing an arrangement state of the robot 2 and the surrounding objects 4.

Returning to FIG. 9, the program generation device 200 next executes S22. In S22, the task generation part 214 confirms whether or not there is an input for arranging the skill box 511 in the flow window 520. For example, the task generation part 214 confirms whether or not the skill box 511 has been dragged from the item window 510 to the flow window 520. When it is determined in S22 that the skill box 511 has been positioned in the flow window 520, the program generation device 200 executes S23. In S23, the task generation part 214 updates the task flow 521 based on the position where the skill box 511 is positioned in the flow window 520.

When the first skill box 511 is positioned in the flow window 520 while the task flow 521 is not drawn in the flow window 520, the task generation part 214 generates the task flow 521 that includes the skill box 511 of the robot system 1. When a new skill box 511 is positioned in the flow window 520 while the task flow 521 is already drawn in the flow window 520, the task generation part 214 adds the new skill box 511 to the task flow 521 based on a relationship between the positions of the skill boxes 511 already included in the task flow 521 and the position where the new skill box 511 is positioned.

For example, when a new skill box 511 is added after all the skill boxes 511 included in the task flow 521, the task generation part 214 adds the new skill box 511 to the end of the task flow 521. When a new skill box 511 is added before all the skill boxes 511 included in the task flow 521, the task generation part 214 adds the new skill box 511 to the beginning of the task flow 521. When a new skill box 511 is added between two skill boxes 511 included in the task flow 521, the task generation part 214 adds the new skill box 511 between the two skill boxes 511.

Next, the program generation device 200 executes S24. In S24, the task generation part 214 confirms whether or not any skill box 511 in the task flow 521 has been selected. When it is determined in S24 that no skill box 511 has been selected, the program generation device 200 returns the process to S22.

When it is determined in S24 that one of the skill boxes 511 has been selected, the program generation device 200 executes S25. In S25, the task generation part 214 generates a skill selection screen. The skill selection screen is a screen for selecting a skill to be associated with the skill box 511 from the multiple skills stored in the skill database 222.

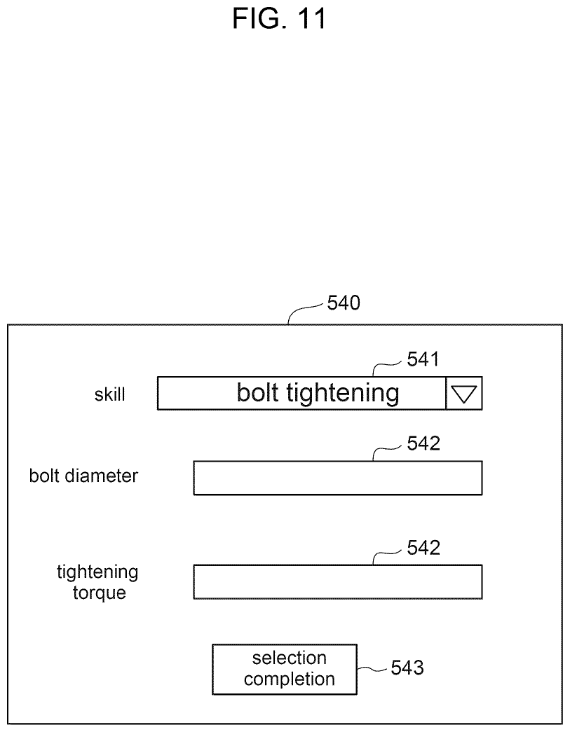

FIG. 11 is a schematic diagram illustrating an example of the skill selection screen. A skill selection screen 540 illustrated in FIG. 11 includes a skill list box 541, a parameter input box 542, and a selection completion button 543. The skill list box 541 is an interface for inputting a skill to be associated with the skill box 511 by selecting one of skills displayed in a drop-down skill list. The skill list includes the multiple skills stored in the skill database 222.

The parameter input box 542 is an interface for inputting one or more parameters to be associated with a skill selected by an input to the skill list box 541. When there are multiple parameters to be associated with the skill, the skill selection screen 540 includes multiple parameter input boxes 542 that respectively correspond to the multiple parameters. In FIG. 11, a bolt tightening skill is selected in the skill list box 541, and a parameter input box 542 for inputting a bolt diameter and a parameter input box 542 for inputting a tightening torque are included in the skill selection screen 540.

The selection completion button 543 is a button for requesting selection of a skill. A skill selection includes associating a skill input in the skill list box 541 and a parameter input in the parameter input box 542 with the skill box 511.

Returning to FIG. 9, the program generation device 200 next executes S26. In S26, the task generation part 214 waits for a request to select a skill. For example, the task generation part 214 waits for the selection completion button 543 to be pressed. Next, the program generation device 200 executes S27. In S27, the task generation part 214 associates the skill input in the skill list box 541 and the parameter input in the parameter input box 542 with the skill box 511.

Next, the program generation device 200 executes S31 and S32. In S31, the task generation part 214 waits for a selection of action reference coordinates based on a specification of coordinates in a simulation. For example, the task generation part 214 waits for a selection of action reference coordinates based on an input specifying coordinates in a simulation image of the simulation window 530. In S32, the task generation part 214 associates selected action reference coordinates specified in the simulation with the skill box 511.

Next, the program generation device 200 executes S33. In S33, the task generation part 214 confirms whether or not there is a task registration request. For example, the task generation part 214 confirms whether or not the task registration button 522 has been pressed. When it is determined in S33 that there is no task registration request, the program generation device 200 returns the process to S22. After that, accepting user operations on the task generation screen 500 is continued until a task registration request is received.

When it is determined in S33 that there is a task registration request, the program generation device 200 executes S34. In S34, the task generation part 214 stores, in the task database 224, a task based on the task flow 521 and the skills and action reference coordinates that are respectively associated with the multiple skill boxes 511 and closes the task generation screen.

### Master Generation Process

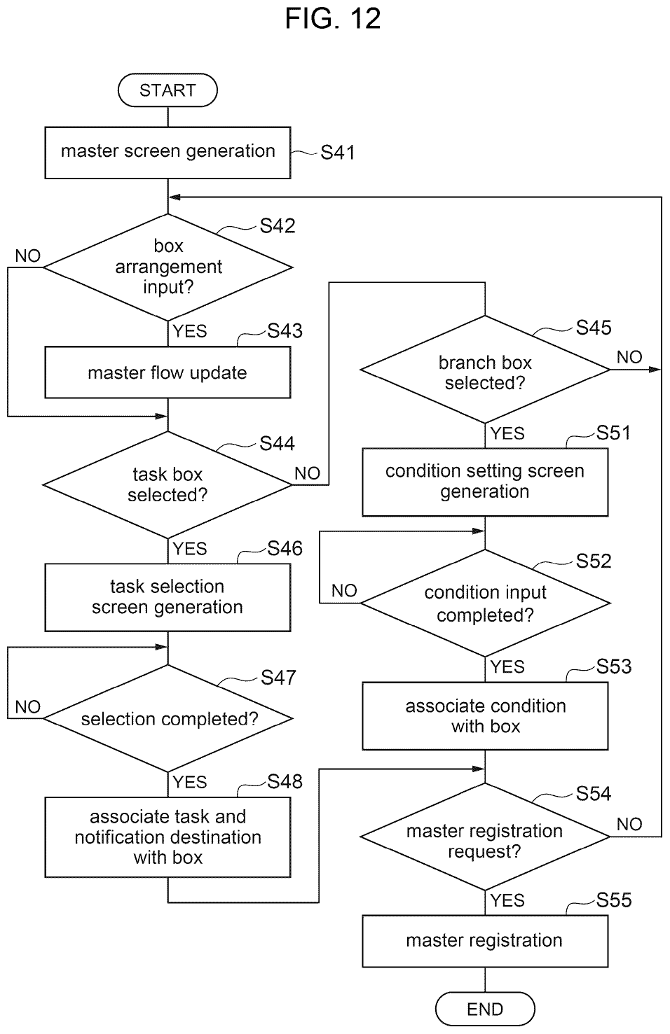

A master generation process includes a master generation procedure, a program generation procedure, a simulation procedure, a calibration procedure, and a program registration procedure. FIG. 12 is a flowchart illustrating an example of the master generation procedure. As illustrated in FIG. 12, the program generation device 200 first executes S41. In S41, the master generation part 215 displays the master generation screen described above on the user interface 295.

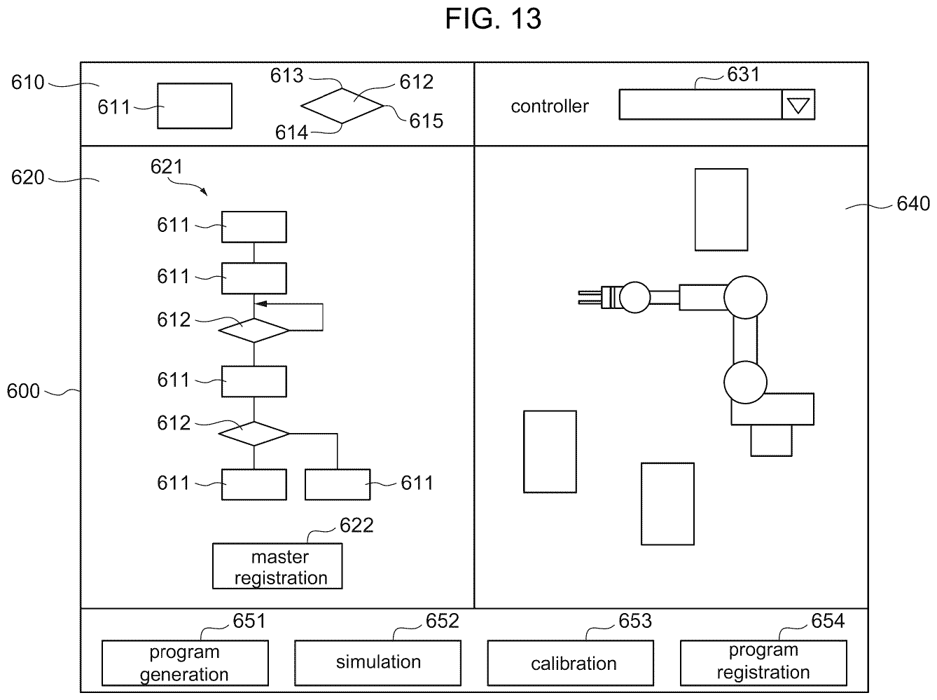

FIG. 13 is a schematic diagram illustrating an example of the master generation screen. A master generation screen 600 illustrated in FIG. 13 has an item window 610, a flow window 620, a controller list box 631, a simulation window 640, a program generation button 651, a simulation button 652, a calibration button 653, and a program registration button 654. The item window 610 is a window that displays items for generating the master flow described above. As an example, the item window 610 includes a task box 611 representing a task of the robot system 1, and a branch box 612 representing a branch determination process of the robot system 1. An example of a branch determination process is a process of determining whether a condition expression is true or false. For example, the branch box 612 branches a master flow 621 based on whether a condition expression is true or false.

As an example, the branch box 612 includes an input terminal 613, a true terminal 614, and a false terminal 615. In the master flow 621, the branch box 612 is executed after an item to which the input terminal 613 is connected. An item connected to the true terminal 614 is executed when the condition expression of the branch box 612 is true. An item connected to the false terminal 615 is executed when the condition expression of the branch box 612 is false. When arranging the branch box 612, it is also possible to connect the false terminal 615 to the input terminal 613. In this case, the branch determination process represented by the branch box 612 corresponds to a wait process that waits for the condition expression to become true.

The flow window 620 is a window for inputting a master flow 621. As an example, by dragging an item (the task box 611 or the branch box 612) from the item window 610 to the flow window 620 and connecting items with a link, it is possible to draw a master flow 621 in the flow window 620. The flow window 620 includes a master registration button 622. The master registration button 622 is a button for requesting registration of a master represented by a master flow.

The master flow 621 illustrated in FIG. 13 includes two branch boxes 612. Of the two branch boxes 612, the branch box 612 positioned upstream represents a wait process. The branch box 612 positioned downstream represents a conditional branching with a task box 611 connected to the true terminal 614 and a task box 611 connected to the false terminal 615.

The controller list box 631 is an interface for inputting a robot controller 100 to be associated with a master flow by selecting one of controllers displayed in a drop-down controller list. By associating a robot controller 100 with a master flow, the robot 2 controlled by the robot controller 100 is associated with the master flow 621. In a case where the robot controller 100 is capable of controlling multiple robots 2, when the robot controller 100 is associated with the master flow 621, the multiple robots 2 are associated with the master flow 621. In this case, in the flow window 620, it is possible to include multiple sub-master flows that respectively correspond to the multiple robots 2 in the master flow 621. The simulation window 640 is a window for displaying a simulation video of the robot 2 that acts based on an action program.

The program generation button 651 is a button for requesting generation of an action program. The simulation button 652 is a button for requesting execution of a simulation. The calibration button 653 is a button for requesting execution of a calibration. The program registration button 654 is a button for requesting registration of an action program.

Returning to FIG. 12, the program generation device 200 next executes S42. In S42, the task generation part 214 confirms whether or not there is an input for arranging an item (a task box 611 or a branch box 612) in the flow window 620. Arranging an item in the flow window 620 includes connecting the newly arranged item to an item previously arranged in the flow window 620 with a link. For example, the task generation part 214 confirms whether or not a task box 611 or a branch box 612 has been dragged from the item window 610 to the flow window 620. When it is determined in S42 that a task box 611 or a branch box 612 has been positioned in the flow window 620, the program generation device 200 executes S43. In S43, the task generation part 214 updates the master flow 621 based on the position where the task box 611 is positioned in the flow window 620.

When the first item is arranged in the flow window 620 while no master flow 621 is drawn in the flow window 620, the master generation part 215 generates a master flow 621 that includes the item of the robot system 1. When a new item is arranged in the flow window 620 while a master flow 621 is already drawn in the flow window 620, the master generation part 215 adds the new item to the master flow 621 based on a connection by a link. When a new item is added between two items included in the master flow 621, the master generation part 215 may add the new item between the two items.

Next, the program generation device 200 executes S44. In S44, the master generation part 215 confirms whether or not one of the task boxes 611 in the master flow 621 has been selected. When it is determined in S44 that no task box 611 has been selected, the program generation device 200 executes S45. In S45, the master generation part 215 confirms whether or not any branch box 612 in the master flow 621 has been selected. When it is determined in S45 that no branch box 612 has been selected, the program generation device 200 returns the process to S42.

When it is determined in S44 that a task box 611 has been selected, the program generation device 200 executes S46. In S46, the master generation part 215 generates a task selection screen. The task selection screen is, for example, a screen for selecting a task to be associated with a task box 611, from the multiple tasks stored in the task database 224.

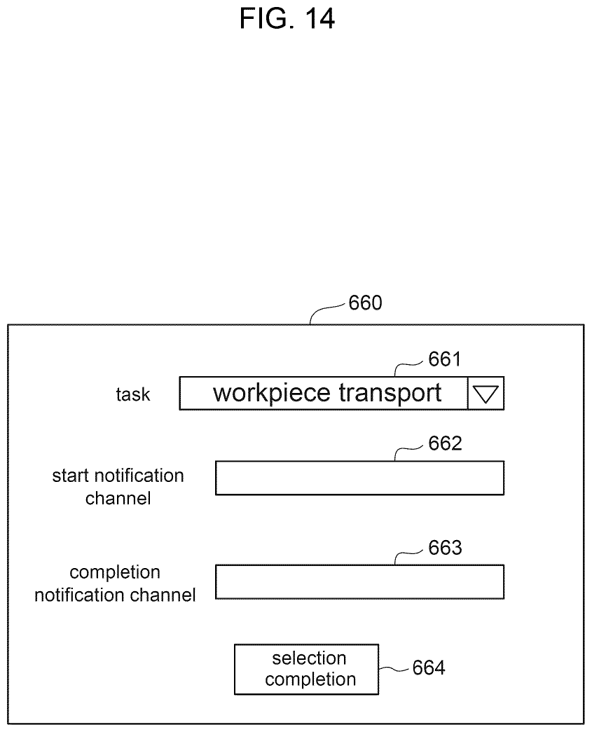

FIG. 14 is a schematic diagram illustrating an example of the task selection screen. A task selection screen 660 illustrated in FIG. 14 includes a task list box 661, a notification destination input box 662, a notification destination input box 663, and a select completion button 664. The task list box 661 is an interface for inputting a task to be associated with the task box 611 by selecting one of tasks displayed in a drop-down task list. The task list includes the multiple tasks stored in the task database 224.

The notification destination input box 662 is an interface for inputting a notification destination for the start of task execution. The notification destination input box 663 is an interface for inputting a notification destination for the completion of task execution. The notification destination input boxes (662, 663) are examples of the notification destination input part described above. The selection completion button 664 is a button for requesting selection of a task. The selection of a task includes associating the task input in the task list box 661 and the notification destinations input in the notification destination input boxes (662, 663) with the task box 611.

Returning to FIG. 12, the program generation device 200 next executes S47. In S47, the master generation part 215 waits for a request to select a task. For example, the master generation part 215 waits for the selection completion button 664 to be pressed. Next, the program generation device 200 executes S48. In S48, the master generation part 215 associates the task input in the task list box 661 and the notification destinations input in the notification destination input boxes (662, 663) with the task box 611.

When it is determined in S45 that a branch box 612 has been selected, the program generation device 200 executes S51. In S51, the master generation part 215 generates a condition setting screen. The condition setting screen is a screen for setting a condition expression to be evaluated in the branch box 612.

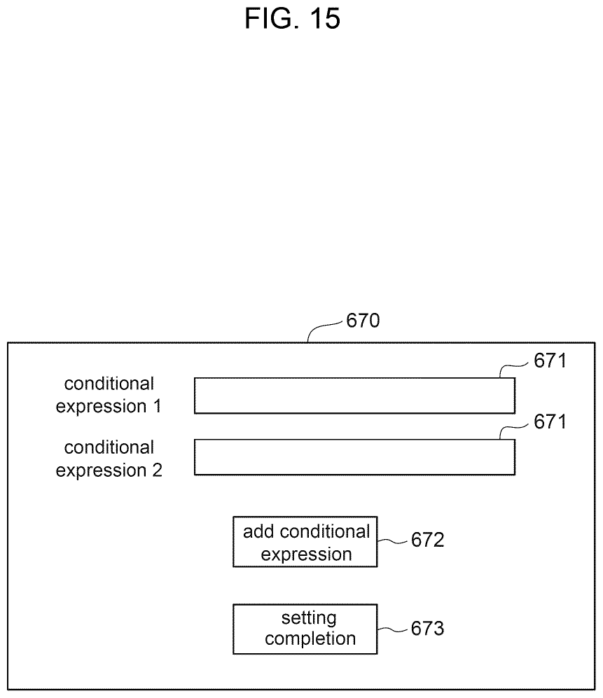

FIG. 15 is a schematic diagram illustrating an example of the condition setting screen. A condition setting screen 670 illustrated in FIG. 15 includes a condition expression input box 671, a condition expression add button 672, and a setting completion button 673. The condition expression input box 671 is an interface for inputting a condition expression using text or the like. The condition expression add button 672 is a button for requesting addition of a condition expression. When the condition expression add button 672 is pressed, a condition expression input box 671 is added. FIG. 15 illustrates an example where two condition expression input boxes 671 are included in the condition setting screen 670 by pressing the condition expression add button 672. The setting complete button 673 is a button for requesting setting of condition expressions. The setting of condition expressions includes associating, with the branch box 612, a condition expression that is obtained by combining all the condition expressions input in the condition expression input boxes 671 with AND or OR operators.

Returning to FIG. 12, the program generation device 200 next executes S52. In S52, the master generation part 215 waits for a request to set a condition expression. For example, the master generation part 215 waits for the setting completion button 673 to be pressed. Next, the program generation device 200 executes S53. In S53, the master generation part 215 associates, with the branch box 612, a condition expression that is obtained by combining all the condition expressions input in the condition expression input boxes 671 with AND or OR operators.

After S48 and S53, the program generation device 200 executes S54. In S54, the master generation part 215 confirms whether or not there is a master registration request. For example, the master generation part 215 confirms whether or not the master registration button 622 has been pressed. When it is determined in S54 that there is no master registration request, the program generation device 200 returns the process to S42. After that, accepting user operations on the master generation screen 600 is continued until a master registration request is received.

When it is determined in S54 that there is a master registration request, the program generation device 200 executes S55. In S55, the master generation part 215 stores the master to the master database 225 based on the master flow 621, the tasks and notification destinations that are respectively associated with the multiple task boxes 611, and the condition expressions associated with the one or more branch boxes 612, and then closes the master generation screen.

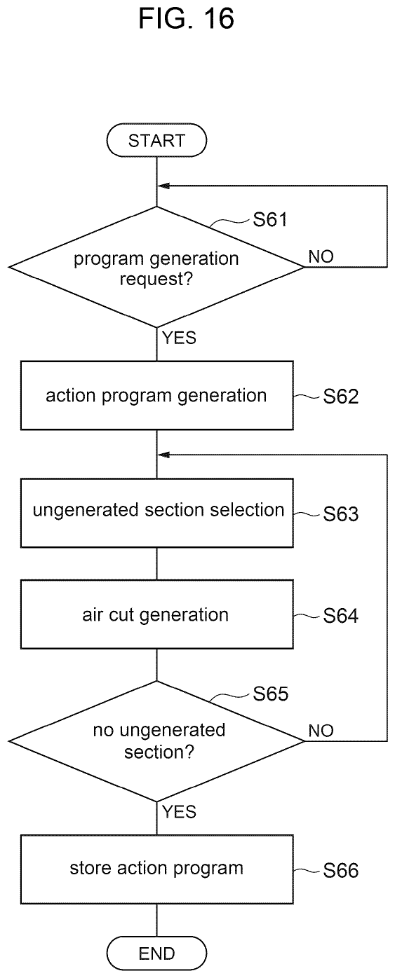

FIG. 16 is a flowchart illustrating an example of a program generation procedure. As illustrated in FIG. 16, the program generation device 200 executes S61, S62, S63, S64, and S65. In S61, the program generation part 216 waits for a request to generate a program. For example, the program generation part 216 waits for the program generation button 651 to be pressed.

In S62, the program generation part 216 generates an action program for the robot 2 in which a relative action is converted into an action of the robot 2, based on a master registered in the master database 225, multiple tasks included in the master, and multiple skills included in each of the multiple tasks. The action program generated here includes multiple work action programs in which relative actions of multiple skills have been converted into actions of the robot 2. Between consecutive work action programs, there may remain ungenerated sections where no program has been generated.

In S63, the program generation part 216 selects an ungenerated section of the robot system 1 from all the ungenerated sections included in the action program. In S64, the program generation part 216 generates the air cut program described above for the selected ungenerated interval. As a result, the selected ungenerated section becomes a section with a generated program.

In S65, the program generation part 216 confirms whether or not there is no ungenerated section remaining in the action program. In S65, when it is determined that there is an ungenerated section remaining, the program generation device 200 returns the process to S63. After that, until there is no ungenerated section remaining in the action program, the selection of an ungenerated section and the generation of an air cut program for the selected ungenerated section are repeated. When it is determined in S65 that there is no ungenerated section remaining, the program generation device 200 executes S66. In S66, the program generation part 216 stores the generated action program in the program storage part 226. As a result, the program generation procedure is completed.

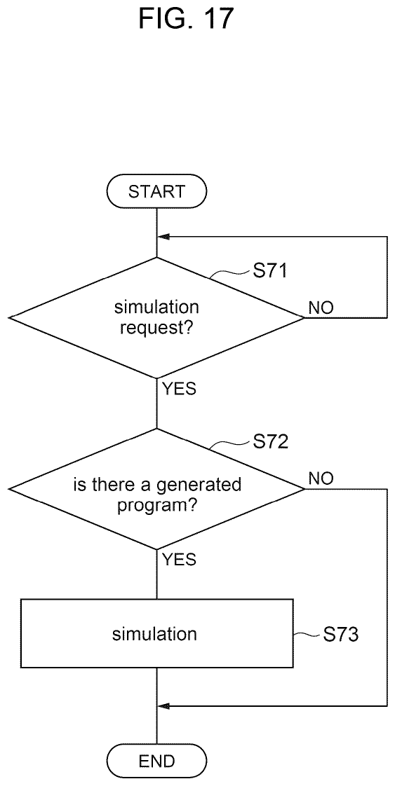

FIG. 17 is a flowchart illustrating an example of a simulation procedure. As illustrated in FIG. 17, the program generation device 200 first executes S71 and S72. In S71, the simulation part 212 waits for a request to execute a simulation. For example, the simulation part 212 waits for the simulation button 652 to be pressed. In S72, the simulation part 212 confirms whether or not a generated action program has been stored in the program storage part 226.

When it is determined in S72 that a generated action program has been stored in the program storage part 226, the program generation device 200 executes S73. In S73, the simulation part 212 generates a simulation video of an action of the robot 2 based on the action program stored in the program storage part 226 and displays the simulation video in the simulation window 640. As a result, the simulation procedure is completed. When it is determined in S72 that there is no generated action program stored in the program storage part 226, the program generation device 200 completes the simulation procedure without executing S73.

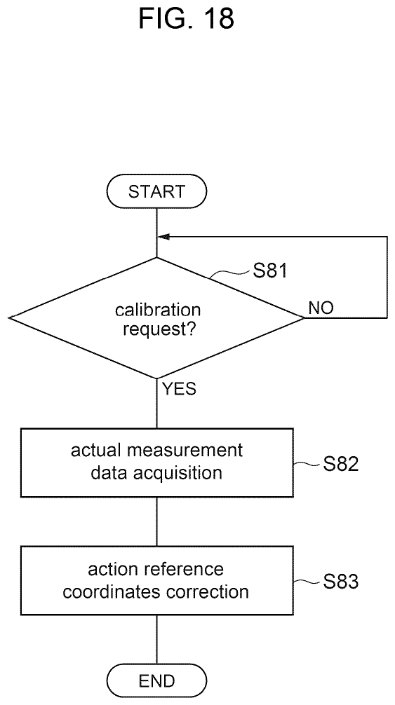

FIG. 18 is a flowchart illustrating an example of a calibration procedure. As illustrated in FIG. 18, the program generation device 200 executes S81, S82, and S83. In S81, the calibration part 218 waits for a request to execute a calibration. For example, the calibration part 218 waits for the calibration button 653 to be pressed. In S82, the calibration part 218 at least acquires actual measurement data of the surrounding objects 4 from the environmental sensor 3. The calibration part 218 may further acquire actual measurement data of the robot 2 from the environmental sensor 3. In S83, the calibration part 218 calculates a difference between the acquired actual measurement data and a position of the model of the surrounding objects 4 in the model storage part 221, and corrects the model in the model storage part 221 to eliminate the difference. When the model in the model storage part 221 is corrected, the simulation part 212 notifies the task generation part 214 of details of the correction. Based on the notified details of the correction, the task generation part 214 corrects the action reference coordinates associated with each of multiple skills in the task database 224. As a result, the calibration procedure is completed.

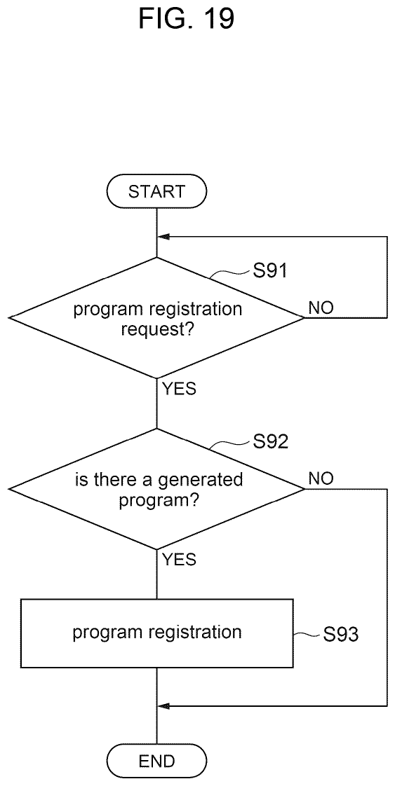

FIG. 19 is a flowchart illustrating an example of a program registration procedure. As illustrated in FIG. 19, the program generation device 200 executes S91 and S92. In S91, the program registration part 217 waits for a request to register a program. For example, the program registration part 217 waits for the program registration button 654 to be pressed. In S92, the program registration part 217 confirms whether or not a generated action program is stored in the program storage part 226.

When it is determined in S92 that a generated action program has been stored in the program storage part 226, the program generation device 200 executes S93. In S93, the action program stored in the program storage part 226 is transmitted to the robot controller 100 and registered in the program storage part 111 of the robot controller 100. As a result, the program registration procedure is completed. When it is determined in S92 that there is no generated action program stored in the program storage part 226, the program generation device 200 completes the registration procedure without executing S93.

### Control Procedure

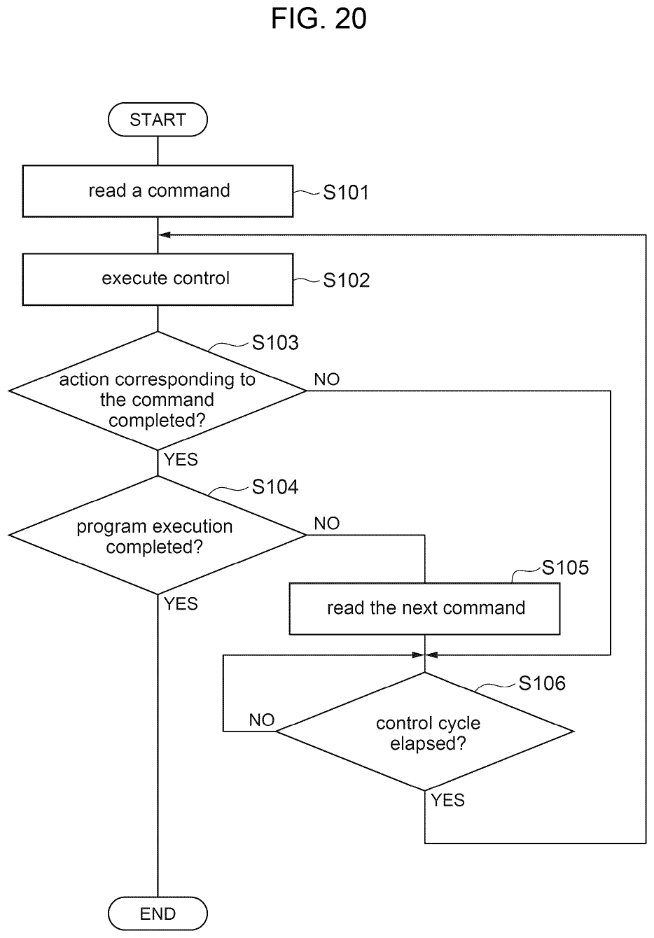

Next, an example of a control procedure executed by the robot controller 100 based on the action program registered in the program storage part 111 is illustrated. As illustrated in FIG. 20, the robot controller 100 first executes S101, S102, and S103. In S101, the control part 112 reads a first action command of the action program from the program storage part 111. In S102, the control part 112 executes the control process described above based on the read action command. In S103, the control part 112 confirms whether or not an action corresponding to the read action command has been completed.

When it is determined in S103 that the action corresponding to the read action command has been completed, the robot controller 100 executes S104. In S104, the control part 112 confirms whether or not actions corresponding to all the action commands in the action program have been completed. When it is determined in S104 that there is a remaining action command of which an action has not been completed, the robot controller 100 executes S105. In S105, the control part 112 reads a next action command from the program storage part 111.

Next, the robot controller 100 executes S106. When it is determined in S103 that the action corresponding to the read action command has not been completed, the robot controller 100 executes S106 without executing S104 and S105. In S106, the control part 112 waits for a control cycle to elapse. After that, the robot controller 100 returns the process to S102. After that, until the actions corresponding to all the action commands in the action program have been completed, the reading of an action command and the control process are repeated.

When it is determined in S104 that the actions corresponding to all the action commands in the action program have been completed, the robot controller 100 completes the control procedure.

As described above, the program generation device 200 generates, based on an operation of a user, an action program for causing the robot 2 to act, and includes: the skill generation part 213 that generates skills and stores the skills in the skill database 222, the skills each representing a relative action; the task generation part 214 that generates a task and stores the task in the task database 224, the task including multiple skills and associating each of the multiple skills with action reference coordinates that serve as a reference for the relative action; and the master generation part 215 that generates a master and stores the master in the master database 225, the master including multiple tasks and associating the multiple tasks with the robot 2.

Since a skill that defines an action is represented by a relative action, the skill can be reused with respect to any action reference coordinates. Therefore, a task can be flexibly structured by a combination of a skill and action reference coordinates. Since a task associates a relative action of a skill with action reference coordinates without limiting an executing entity, a task also can be reused with respect to any executing entity. Therefore, a master can be flexibly constructed by a combination of a task and an executing entity. Consequently, this is effective for improving efficiency of action program generation.

The master generation part 215 may generate a master that associates a start condition with one or more tasks. A more advanced action program including determination of a start condition can be easily generated.

The master generation part 215 may generate a master that associates a notification destination for an execution status by the robot 2 with one or more tasks. An action program that includes coordination with a host controller can be easily generated.

The task generation part 214 may generate a task that includes an execution order of multiple skills, and the master generation part 215 may generate a master that includes a conditional branching between two or more tasks. Two or more skills with a fixed execution order can be grouped into a single task, and a conditional branching between two or more tasks that depends on an executing entity or the like can be concentrated in a master. Therefore, an action program can be more easily generated.

The task generation part 214 may generate a task that associates one or more parameters that define a variable action in a relative action with one or more skills. A variable action in a relative action can change depending on positioning of a skill within a task. By enabling association of one or more parameters with a skill in a task generation stage, it becomes easier to adapt a variable action to a task.

The skill generation part 213 may generate a skill that includes at least a start position and an end position of a relative action. Since a start position and an end positions are defined as a relative action, the robot 2 can be moved with respect to a master that arranges tasks that connect skills.

The skill generation part 213 may generate a skill that includes an approach action from the start position to a work start position and a depart action from a work end position to the end position. By including an approach action and a depart action in a skill, usability of the skill in task generation can be improved.

The skill generation part 213 may generate a skill by extracting at least a part of a generated action program and converting it into a relative action. A generated action program can be effectively utilized.

The program generation part 216 may be further provided that generates an action program for the robot 2 in which a relative action is converted into an action of the robot 2, based on a master, multiple tasks included in the master, and multiple skills included in each of the multiple tasks. An action of the robot 2 specified by skills, tasks, and a master can be easily applied to an existing robot controller that acts based on an action program.

The master generation part 215 may generate a master by associating multiple tasks to be executed with respect to one workpiece with multiple executing entities including the robot 2, and the program generation part 216 may generate an action program for each of the multiple executing entities. When multiple tasks to be executed with respect to one workpiece are consolidated into one master, an action program can be generated by allocating the multiple tasks to multiple executing entities. Therefore, it becomes easier to generate an action program with a workpiece-centric approach.

The program generation part 216 may generate an action program that includes an air cut program for causing the robot 2 to act from an end position of an action of the robot 2 corresponding to a relative action of a preceding skill to a start position of an action of the robot 2 corresponding to a relative action of a subsequent skill, in consecutive skills. It becomes possible to easily generate an air cut program with a determined executing entity from a skill of which an executing entity is not yet determined.

The program generation device 200 may further include the simulation part 212 that executes a simulation including a model of the robot 2 and a model of the surrounding objects 4 of the robot 2, and the task generation part 214 may associate action reference coordinates with each of the multiple skills based on an input that specifies coordinates in the simulation. Action reference coordinates to be associated with a skill can be easily specified.

The program generation device 200 may further include the calibration part 218 that corrects the action reference coordinates based on a difference between actual measurement data of the peripheral objects 4 and the model of the peripheral objects 4. By applying the difference between the actual measurement data and the model to the action reference coordinates, an action of the robot 2 can be easily adapted to a real environment.

The program generation device 200 may further include the preview display part 219 that associates a provisional robot 2 and provisional action reference coordinates with a skill generated by the skill generation part 213 and displays a simulation of a case where the provisional robot 2 executes the skill at the provisional action reference coordinates. Actions of skills can be sequentially confirmed.

The skill generation part 213 may generate a type input interface that allows an input of a skill type, generate a skill input interface corresponding to the skill type based on an input to the type input interface, and generate a skill based on an input to the skill input interface. This can prompt the user to provide an appropriate input.

Japanese Patent No. 6455646 describes a programming assistance device for a robot. The programming assistance device includes: a work job storage part that stores multiple work jobs; a first condition setting part that sets an environmental condition specifying an action environment of a robot for any of the multiple work jobs, in response to an input to a user interface; a second condition setting part that sets multiple target work jobs to be executed by the robot from among the multiple work jobs, in response to an input to the user interface; and a planning assistance part that determines, based on an execution order, whether or not at least one work job satisfies the environmental condition in an execution flow that defines the execution order of the multiple target work jobs set by the second condition setting part.

A program generation device according to one aspect of the present disclosure generates, based on an operation of a user, an action program for causing a robot to act, and includes: a skill generation part that generates skills and stores the skills in a skill database, the skills each representing a relative action; a task generation part that generates a task and stores the task in a task database, the task including multiple skills and associating each of the multiple skills with action reference coordinates that serve as a reference for the relative action; and a master generation part that generates a master and stores the master in a master database, the master including multiple tasks and associating the multiple tasks with the robot.

A program generation method according to another aspect of the present disclosure includes: generating a skill and storing the skill in a skill database by a skill generation part, the skill representing a relative action; generating a task and storing the task in a task database by a task generation part, the task including multiple skills and associating each of the multiple skills with action reference coordinates that serve as a reference for the relative action; and generating a master and storing the master in a master database by a master generation part, the master including multiple tasks and associating the multiple tasks with the robot.

A program generation device according to an embodiment of the present invention is effective in improving efficiency in generating an action program.

Obviously, numerous modifications and variations of the present invention are possible in light of the above teachings. It is therefore to be understood that within the scope of the appended claims, the invention may be practiced otherwise than as specifically described herein.

1. A generation device for generating an action program for a robot based on an operation of a user, comprising:
processing circuitry configured to generate skill information including a plurality of skills each corresponding to a relative robot action, store the skill information in a skill database, generate a task including a plurality of skills each associating with action reference coordinates that serve as a reference for the relative robot action, store the task in a task database, generate a master including a plurality of tasks associating with the robot, and store the master in a master database.

2. The generation device according to claim 1, wherein the processing circuitry is configured to generate the master that associates a start condition with at least one task.

3. The generation device according to claim 1, wherein the processing circuitry is configured to generate the master that associates a notification destination for an execution status by the robot with at least one task.

4. The generation device according to claim 1, wherein the processing circuitry is configured to generate the task that includes an execution order of the skills in the task and generate the master that includes a conditional branching between two or more tasks.

5. The generation device according to claim 4, wherein the processing circuitry is configured to generate the task that associates at least one parameter that defines a variable action in the relative robot action with at least one skill.

6. The generation device according to claim 1, wherein the processing circuitry is configured to generate a skill that includes at least a start position and an end position of the relative robot action.

7. The generation device according to claim 6, wherein the processing circuitry is configured to generate the skill that includes an approach action from the start position to a work start position and a depart action from a work end position to the end position.

8. The generation device according to claim 6, wherein the processing circuitry is configured to generate the skill by extracting at least a part of a generated action program and converting the generated action program into the relative robot action.

9. The generation device according to claim 1, wherein the processing circuitry is configured to generate the action program for the robot in which the relative robot action is converted into an action of the robot based on the master, the tasks in the master, and the skills in each of the tasks.

10. The generation device according to claim 9, wherein the processing circuitry is configured to associate the tasks to be executed with respect to one workpiece with a plurality of executing entities including the robot and generate the action program for each of the executing entities.

11. The generation device according to claim 9, wherein the processing circuitry is configured to generate the action program including an air cut program that causes the robot to move directly from an end position of an action corresponding to the relative robot action of a preceding skill to a start position of an action corresponding to the relative robot action of a subsequent skill in consecutive skills.

12. The generation device according to claim 1, wherein the processing circuitry is configured to execute a simulation including a model of the robot and a model of a surrounding object of the robot and associate action reference coordinates with each of the skills in the task based on an input specifying coordinates in the simulation.

13. The generation device according to claim 12, wherein the processing circuitry is configured to correct the action reference coordinates based on a difference between actual measurement data of the surrounding object and the model of the surrounding object.

14. The generation device according to claim 1, wherein the processing circuitry is configured to associate a provisional robot and provisional action reference coordinates with one of the skills in the skill information and instruct display of a simulation of a case where the provisional robot executes the one of the skills in the skill information at the provisional action reference coordinates.

15. The generation device according to claim 1, wherein the processing circuitry is configured to generate a type input interface that allows an input of a type of skill, generate a skill input interface corresponding to the type of the skill based on an input to the type input interface, and generate the skill based on an input to the skill input interface.

16. The generation device according to claim 1, wherein the processing circuitry is configured to generate an upper-level master including a conditional branching between a plurality of masters and store the upper-level master in the master database.

17. The generation device according to claim 16, wherein the processing circuitry is configured to generate the action program for the robot in which the relative robot action is converted into an action of the robot based on the upper-level master, the masters, the tasks in each of the masters, and the skills in each of the tasks.

18. The generation device according to claim 2, wherein the processing circuitry is configured to generate the master that associates a notification destination for an execution status by the robot with at least one task.

19. The generation device according to claim 2, wherein the processing circuitry is configured to generate the task that includes an execution order of the skills in the task and generate the master that includes a conditional branching between two or more tasks.

20. A generation method for generating an action program for a robot, comprising:
generating, using processing circuitry, skill information including a plurality of skills each corresponding to a relative robot action;
storing, using the processing circuitry, the skill information in a skill database;
generating, using the processing circuitry, a task including a plurality of skills and each associating with action reference coordinates that serve as a reference for the relative robot action;
storing, using the processing circuitry, the task in a task database;
generating, using the processing circuitry, a master including a plurality of tasks associating with a robot; and
storing, using the processing circuitry, the master in a master database.
